(19) United States
(12) Patent Application Publication
(10) Pub. No.: US 2009/0219798 A1
(43) Pub. Date: Sep. 3, 2009

(54) REPRODUCTION METHOD AND HOLOGRAM RECORDING MEDIUM

(75) Inventors: Kenji TANAKA, Tokyo (JP); Atsushi Fukumoto, Kanagawa (JP); Masaaki Hara, Tokyo (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: Sony Corporation, Tokyo (JP)

(21) Appl. No.: 12/357,865

(22) Filed: Jan. 22, 2009

(30) Foreign Application Priority Data
Feb. 28, 2008 (JP) 2008-048039

(51) Int. Cl. G11B 7/00; G03H 1/04

(52) U.S. Cl. 369/103; 359/3

(57) ABSTRACT

Disclosed is a reproduction method for a hologram recording medium on which information is recorded with interference fringes of signal light and reference light, including: generating, based on light from a first light source, the reference light and coherent light caused to have uniform amplitude and phase, and irradiating the hologram recording medium with the reference light and the coherent light, the hologram recording medium including a recording layer on which the information is recorded with the interference fringes of the signal light and the reference light, a first reflection film formed on a lower surface side of the recording layer, and a gap layer formed between the recording layer and the first reflection film; and receiving the coherent light and a reproduction image that corresponds to recording information and is obtained as reflection light from the hologram recording medium through light irradiation in the light irradiation step, and reproducing the information based on a result of the light received.

### CROSS REFERENCES TO RELATED APPLICATIONS

The present invention contains subject matter related to Japanese Patent Application JP 2008-048039 filed in the Japanese Patent Office on Feb. 28, 2008, the entire contents of which being incorporated herein by reference.

### BACKGROUND OF THE INVENTION

1. Field of the Invention

The present invention relates to a reproduction method for a hologram recording medium on which data is recorded with interference fringes of reference light and signal light, and a hologram recording medium.

2. Description of the Related Art

As disclosed in Japanese Patent Application Laid-open No. 2006-107663 and Japanese Patent Application Laid-open No. 2007-79438 (hereinafter, referred to as Patent Documents 1 and 2, respectively), there is known a hologram recording/reproducing method in which data is recorded with interference fringes of signal light and reference light and the data recorded with the interference fringes is reproduced through irradiation with the reference light. As the hologram recording/reproducing method, a so-called coaxial system in which data is recorded with the signal light and the reference light being coaxially arranged is known.

FIGS. 12 and 13 are diagrams for illustrating a method of recording/reproducing a hologram with the coaxial system. FIG. 12 is a diagram regarding a recording method, and FIG. 13 are diagrams regarding a reproducing method.

First, in FIG. 12, at the time of recording, a spatial light modulation (e.g., light intensity modulation) is performed on incident light from a light source at an SLM (Spatial Light Modulator) 101, to thereby generate signal light and reference light coaxially arranged as shown in the figure. The SLM 101 is constituted of a liquid crystal panel and the like.

In this case, the signal light is subjected to the spatial light modulation according to recording data to be generated, and the reference light is subjected to the spatial light modulation with a predetermined pattern to be generated.

The signal light and the reference light thus generated in the SLM 101 are subjected to spatial phase modulation by a phase mask 102. As shown in FIG. 12, the phase mask 102 gives a random phase pattern to the signal light and gives a predetermined phase pattern to the reference light.

Here, the reason why the phase modulation is performed on the reference light is to enable multiple recording on the hologram recording medium as described in Patent Document 1. That is, signal light (data) recorded using reference light having a certain phase structure can be read only by performing irradiation with reference light having the same phase structure when reproducing the data. Therefore, by using this, data is subjected to multiple recording using reference light having different phase structures when recording data. When the data is reproduced, by performing alternative irradiation with the reference light having those phase structures, data items that have been subjected to multiple recording can be selectively read.

Further, the reason why the random phase modulation pattern is given to the signal light is to improve an interference efficiency of the signal light and the reference light and to spread spectrums of the signal light, to thereby suppress DC components and increase a recording density.

As a phase modulation pattern given to the signal light, a binary random pattern using, e.g., “0” and “n” is set. Specifically, a random phase modulation pattern is set so that a ratio of pixels not subjected to the phase modulation (i.e., phase=0) and pixels subjected to phase modulation by n (180 degrees) is 1:1.

Here, through the light intensity modulation by the SLM 101, light whose light intensity is modulated into “0” and “1” according to the recorded data is generated as the signal light. The phase modulation is performed by “0” or “n” with respect to the signal light, to thereby generate light having light wave-front amplitudes of “−1”, “0”, and “1 (+1)”. That is, when a pixel whose light intensity is “1” is subjected to the phase modulation by “0”, the amplitude becomes “1”, and when subjected to the phase modulation by “n”, the amplitude becomes “−1”. It should be noted that even when a pixel whose light intensity is “0” is subjected to the phase modulation by “0” or “n”, the amplitude remains “0”.

The signal light is obtained through an intensity modulation according to recording data. Accordingly, the light intensities (amplitudes) of “0” and “1” are not necessarily disposed at random, which assists the DC components in occurring.

The phase pattern given by the phase mask 102 is a random pattern. Therefore, pixels having a light intensity of “1” (pixel having an amplitude of “1”) in the signal light output from the SLM 101 can be divided at random (into halves) to obtain pixels whose amplitudes are “1” and “−1”. As a result, spectrums can be uniformly scattered on a Fourier plane (image on a medium), and thus the DC components can be suppressed in the signal light.

If the DC components of the signal light can be suppressed in this way, the recording density of data can be increased.

Here, the DC components are generated in the signal light, which causes a recording material to significantly react therewith. As a result, the above-mentioned multiple recording becomes impossible. In other words, further multiple recording of data cannot be performed on a portion on which the DC components are recorded.

If the DC components can be suppressed with the random phase pattern as described above, the multiple recording of the data becomes possible, with the result that the recording density can be increased.

Let us get back to the original point.

The signal light and the reference light that have been subjected to the phase modulation by the phase mask 102 are focused by an objective lens 103 and irradiated onto on a hologram recording medium 100. As a result, on the hologram recording medium 100, interference fringes (diffraction grating: hologram) corresponding to the signal light (recording image) are formed. Thus, data is recorded by forming the interference fringes.

Subsequently, for data reproduction, first, only reference light is generated through the spatial light modulation (intensity modulation) by the SLM 101 with respect to the incident light, as shown in FIG. 13A. To the reference light thus generated, the same predetermined phase pattern as in the case of recording is given through the spatial light phase modulation by the phase mask 102.

To make sure, a description will be given on the reference light generated at the time of reproduction with reference to FIG. 14.

FIG. 14A is a diagram showing reference light generated through intensity modulation by the SLM 101 at the time of reproduction. FIG. 14B is a diagram showing reference light that has been subjected to phase modulation by the phase mask 102. In FIGS. 14A and 14B, color densities represent a magnitude relation of light amplitudes. Specifically, a change in color from black to white represents a change in amplitude from “0” to “1” in FIG. 14A, and a change in color from black, through gray, to white represents a change in amplitude from “−1”, through “0”, to “1 (+1)” in FIG. 14B.

It can be confirmed from FIGS. 14A and 14B that the phase pattern is given to the reference light by the phase mask 102, to thereby divide the pixels that have been modulated with the intensity of “1” and have the amplitude of “1” into pixels whose amplitude is “1” (phase=0) and pixels whose amplitude is “−1” (phase=n).

In FIG. 13A, with the reference light that has been subjected to the phase modulation by the phase mask 102, the hologram recording medium 100 is irradiated through the objective lens 103.

At this time, the same phase pattern as that in the case of recording is given to the reference light. By irradiating the hologram recording medium 100 with such reference light, diffraction light corresponding to a hologram image recorded is obtained as shown in FIG. 13B, to be output as reflection light from the hologram recording medium 100. Thus, a reproduction image corresponding to the recording data can be obtained.

Then, the reproduction image thus obtained is received by an image sensor 104 such as a CCD (Charge Coupled Device) sensor and a CMOS (Complementary Metal Oxide Semiconductor) sensor, and recording data is reproduced based on a light-receiving signal of the image sensor 104.

### SUMMARY OF THE INVENTION

Incidentally, in the above-described method of recording/reproducing a hologram in related art, the phase modulation (“0” and “n”) is performed using the phase mask 102 at the time of recording, and the hologram recording medium 100 is irradiated with the signal light having the amplitudes of “−1”, “0”, and “1”. Because the hologram recording medium 100 can record the phase information, in addition to the light intensity information, the information of the amplitude of “−1” obtained through the phase modulation by “n” is recorded on the hologram recording medium 100 as it is.

In contrast, however, it is difficult for the image sensor 104 to detect the phase information recorded on the hologram recording medium 100. In other words, the amplitude information of “−1” obtained through the phase modulation by “n” is difficult to be detected.

In this case, the image sensor 104 detects the light intensity as an absolute value (square value) of the amplitude recorded. For this reason, the amplitude of “−1” recorded through the phase modulation by “n” and the amplitude of “1” recorded through the phase modulation by “0” can only be detected as the same light intensity of “1”.

As described above, in a hologram recording/reproducing system, a medium thereof can record the phase information, but the phase information is difficult to be detected by an apparatus thereof. Thus, nonlinearity is caused in this point.

By the past recording/reproducing method as described with reference to FIGS. 12 and 13, it is extremely difficult to reproduce data appropriately based on the light-receiving signal obtained by the image sensor 104 due to the nonlinearity, which is considered as a problem.

In view of the above, the present applicant has proposed various reproduction methods that use a coherent addition for avoiding the nonlinearity problem.

The coherent addition is a collective term of methods of irradiation with not only the reference light but also coherent light generated so that a light amplitude (intensity) and a phase become uniform at the time of reproduction. Specifically, in the case of using the coaxial system as shown in FIGS. 12 and 13, the coherent light is generated in an area where the signal light is generated at the time of recording.

By performing irradiation with the reference light and the coherent light at the time of reproduction as described above, the coherent light can be added while interfering with the reproduction image obtained from the hologram recording medium 100 according to the irradiation with the reference light. That is, by the application of the coherent addition, the image sensor 104 detects components generated by adding the coherent light to the reproduction image.

By performing reproduction through the coherent addition as described above, the following advantages can be obtained:
1. linearity of the hologram recording/reproducing system is ensured, and
2. a contrast of the reproduction image is increased and an S/N is improved.

In particular, the advantage of the above item 1 enables a signal processing performed on the light-receiving signal of the image sensor 104, particularly, a signal processing for suppressing intersymbol interference (inter-pixel interference) to effectively work. As a result, it is possible to make the data reproduction based on the light-receiving signal easier to be implemented.

In addition, the advantage of the above item 2 significantly contributes to implementation of the data reproduction with more practicality.

As described above, by performing reproduction through the coherent addition, a variety of excellent effects such as implementation of the data reproduction with more practicality can be obtained.

However, because the coherent light is generated so that the amplitude and phase thereof are uniform, when the hologram recording medium 100 is irradiated with the coherent light, a light spot is generated in the hologram recording medium 100, resulting in occurrence of a very strong peak.

Thus, there is a fear in that the reproduction through the coherent addition may cause corruption of the recording data during reproduction or give damage to the recording material.

In view of the above-mentioned circumstances, it is desirable to provide the following reproduction method with respect to the hologram recording medium on which information is recorded with the interference fringes of the signal light and the reference light.

That is, according to an embodiment of the present invention, there is provided a reproduction method for a hologram recording medium on which information is recorded with interference fringes of signal light and reference light. The reproduction method includes generating, based on light from a first light source, the reference light and coherent light caused to have uniform amplitude and phase, and irradiating the hologram recording medium with the reference light and the coherent light, the hologram recording medium including a recording layer on which the information is recorded with the interference fringes of the signal light and the reference light, a first reflection film formed on a lower surface side of the recording layer, and a gap layer formed between the recording layer and the first reflection film.

The reproduction method further includes receiving the coherent light and a reproduction image that corresponds to recording information and is obtained as reflection light from the hologram recording medium through light irradiation in the light irradiation step.

In the reproduction method, the light irradiation step includes performing irradiation with light, as the coherent light, obtained by giving a predetermined phase difference to a reference phase in the reference light

In the reproduction method for a hologram recording medium including a substrate having a structure whose cross section has a convex-concave shape and a second reflection film formed on a convex-concave surface of the substrate on a lower surface side of the first reflection film, the first reflection film reflecting light from the first light source and causing light from a second light source to pass therethrough, the light from the second light source having a wavelength different from the light from the first laser light source, the light irradiation step includes irradiating the hologram recording medium with the light from the second light source along with the reference light and the coherent light through a common objective lens, the reproduction method further including performing, based on a result of detecting reflection light from the second light source reflected by the second reflection film, position control on the objective lens in a focus direction.

In the reproduction method, the light irradiation step includes irradiating the hologram recording medium in which the gap layer has a thickness of less than 50 μm.

In the reproduction method, the light irradiation step includes irradiating the hologram recording medium in which the gap layer has a thickness of 10 to 20 μm.

Further, according to another embodiment of the present invention, there is provided a hologram recording medium having the following structure.

The hologram recording medium includes a recording layer on which information is recorded with interference fringes of signal light and reference light, a first reflection film formed on a lower surface side of the recording layer, and a gap layer formed between the recording layer and the first reflection film.

The hologram recording medium further includes a substrate having a structure whose cross section has a convex-concave shape and a second reflection film formed on a convex-concave surface of the substrate, the substrate and the second reflection film being disposed on a lower surface side of the first reflection film.

In the hologram recording medium, the first reflection film reflects light from a first light source serving as a light source of the reference light and causes light from a second light source to pass therethrough, the light from the second light source having a wavelength different from the light from the first light source.

In the hologram recording medium, the gap layer has a thickness of less than 50 μm.

In the hologram recording medium, the gap layer has a thickness of 10 to 20 μm.

According to the embodiments of the present invention, in the hologram recording medium, the gap layer (light transmission layer) is formed on a lower surface side of the recording layer and on an upper surface side of the reflection film. A focus point (focal point) of the irradiation light is controlled according to the reflection light reflected by the reflection film formed in the hologram recording medium. Accordingly, by thus inserting the gap layer between the recording layer and the reflection film, the recording layer and the focus point can be distanced that much.

As described above, according to the present invention, the formation of the gap layer can set the focus point of the irradiation light and the recording layer apart from each other. In other words, it is possible to perform defocusing in an amount corresponding to the thickness of the gap layer. With this structure, in the case of performing reproduction from the hologram recording medium through irradiation of the reference light and the coherent light with the coherent addition, the peak intensity of the light spot due to the coherent light can be effectively suppressed, and corruption of the recording data and occurrence of damage to the recording layer (recording material) can be prevented.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a diagram showing a cross-sectional structure of a hologram recording medium according to an embodiment of the present invention;

FIG. 2 is a block diagram showing an inner structure of a recording/reproducing apparatus according to the embodiment;

FIG. 3 is a diagram showing a structure of a spatial light modulation portion provided to the recording/reproducing apparatus according to the embodiment;

FIG. 4 are diagrams for explaining a structure of a liquid crystal element in a phase modulator;

FIG. 5 is a diagram for explaining sectioned areas of the spatial light modulation portion;

FIG. 6 are diagrams for explaining output light from an intensity modulator and the phase modulator at the time of recording;

FIG. 7 is a diagram showing a representation in which signal values recorded on the hologram recording medium are indicated by using a real-number axis and an imaginary-number axis;

FIG. 8 is a diagram showing a state where coherent light is added using the real-number axis and the imaginary-number axis;

FIG. 9 are diagrams for explaining output light from the intensity modulator and the phase modulator at the time of reproduction through coherent addition;

FIG. 10 is a graph showing a relationship between a depth position of irradiation light and a peak intensity of a light spot;

FIG. 11 is a graph showing a relationship between a thickness of a gap layer and a diffraction efficiency;

FIG. 12 is a diagram for explaining a recording method using a coaxial system;

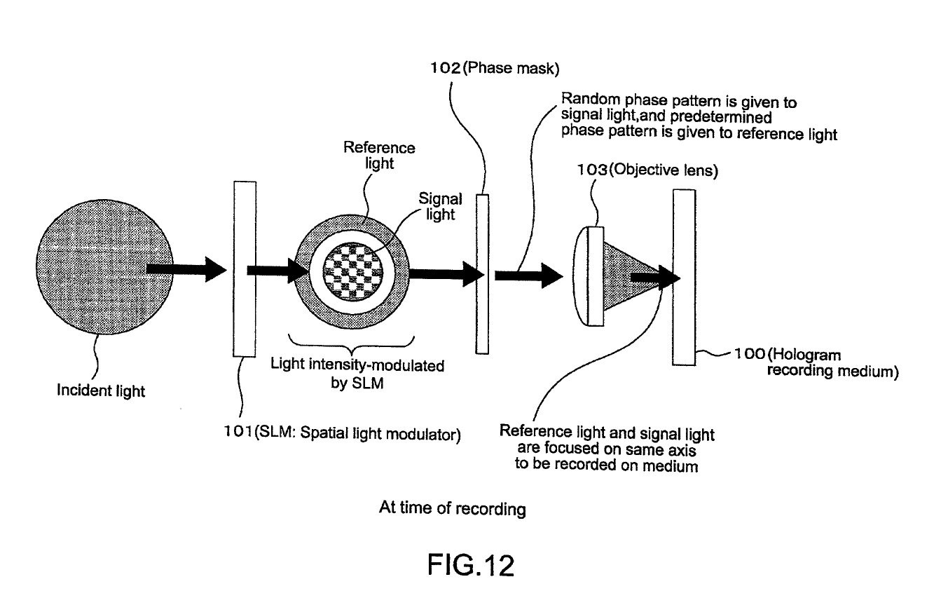

FIG. 13 are diagrams for explaining a reproduction method in related art; and

FIG. 14 are diagrams for explaining reference light irradiated at the time of reproduction in related art.

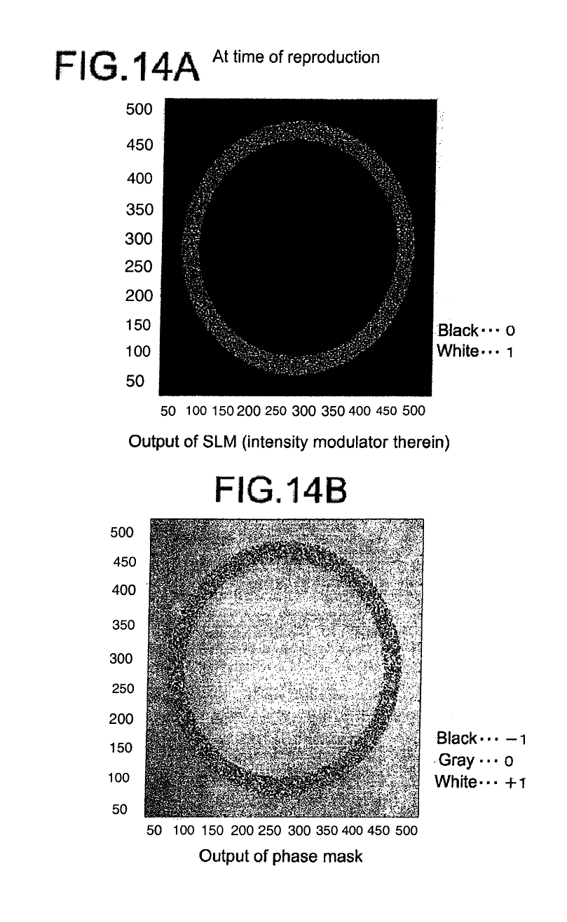

### DESCRIPTION OF PREFERRED EMBODIMENTS

Hereinafter, the best mode (hereinafter, referred to as an embodiment) of the present invention will be described with reference to the drawings.

[Structure of Hologram Recording Medium]

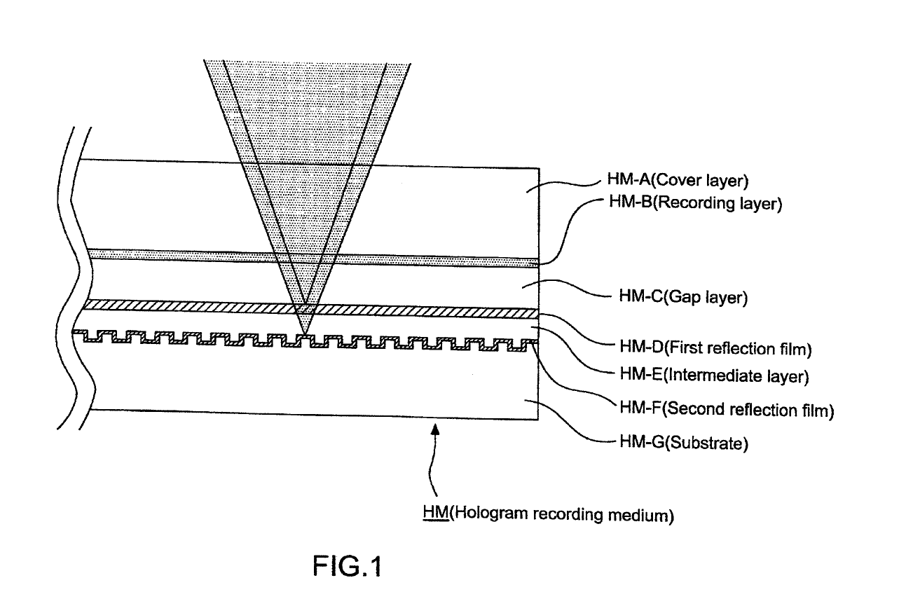

FIG. 1 is a diagram showing a cross-sectional structure of a hologram recording medium HM according to an embodiment of the present invention.

First, the hologram recording medium HM of this embodiment has a disc-like shape. As can be seen from the cross-sectional structure of the hologram recording medium HM of FIG. 1, assuming that light from a recording/reproducing apparatus (described later) enters the hologram recording medium from an upper layer to a lower layer thereof, a cover layer HM-A, a recording layer HM-B, a gap layer HM-C, a first reflection film HM-D, an intermediate layer HM-E, a second reflection film HM-F, and a substrate HM-G are formed in the stated order from the upper layer side.

The cover layer HM-A is made of, for example, glass, and is provided for protecting the recording layer HM-B formed thereunder.

The recording layer HM-B is a layer on which information is recorded with interference fringes of signal light and reference light. The recording layer HM-B is formed of a material (recording material) having a property in which monomers change into polymers by being irradiated with light having a predetermined wavelength.

Here, in the recording material used for the hologram recording medium HM, the monomers are changed into the polymers with a crude density, and the interference fringes can be multiply formed on the same position until the monomers are exhausted. Thus, multiple recording of data can be performed.

Specifically, the recording material in this case is structured so that the interference fringes are formed in response to blue-violet laser light having a wavelength of, e.g., 410 nm emitted from a first laser 1 as a light source provided to the recording/reproducing apparatus (described later).

On a lower layer side of the recording layer HM-B, the first reflection film HM-D is formed on the other side of the gap layer HM-C (described later).

The first reflection film HM-D is provided for returning, when a reproduction image (reproduction light) corresponding to the interference fringes (data recorded) formed on the recording layer HM-B through the irradiation of the reference light from the first laser 1 is obtained at the time of reproduction, the reproduction image (reproduction light) to the recording/reproducing apparatus side as reflection light.

The first reflection film HM-D has wavelength selectivity. Specifically, the first reflection film HM-D reflects the blue-violet laser light emitted from the first laser 1 described above, but causes red laser light having a wavelength of, e.g., 650 nm emitted from a second laser 14 (described later) to pass therethrough.

Under the first reflection film HM-D, the substrate HM-G on which the second reflection film HM-F is formed is formed on the other side of the intermediate layer HM-E.

On the substrate HM-G, a pit row is spirally formed from an inner circumferential side toward an outer circumferential side of the hologram recording medium HM, for example. That is, the pit row forms a recording track. By the pit row, required information such as address information is recorded.

On a surface side (on a convex-concave surface side) of the substrate HM-G on which the track is spirally formed, the second reflection film HM-F is formed by a sputtering or vapor deposition method, for example. The second reflection film HM-F reflects the red laser light emitted from the second laser 14.

An upper surface side of the second reflection film HM-F is bonded to a lower surface side of the first reflection film HM-D by a bonding adhesive such as a resin serving as the intermediate layer HM-E.

As can be seen from the above description, the hologram recording medium HM of this embodiment is provided with the layer (second reflection film HM-F) on which information is recorded with the pit row on a lower surface side of the recording layer HM-B on which information is recorded with a hologram. The recording layer on which information is recorded with the pit row is irradiated with light (second laser light emitted from the second laser 14) different from light (first laser light emitted from the first laser 1) for recording/reproduction of the hologram. The second laser light has a wavelength different from that of the first laser light.

In the recording/reproducing apparatus described later, the reflection light from the second reflection film HM-F obtained through irradiation with the second laser light is used to perform various position control actions such as various servo control actions including a tracking servo and a focus servo and access control based on address information. In other words, through irradiation with additional laser light having the wavelength different from that of the laser light for recording/reproduction of the hologram, the various position control actions for recording/reproduction are performed.

Here, the reason why the various position control actions for the recording/reproduction are performed using the additional laser light having the wavelength different from that of the laser light for the hologram recording/reproduction is as follows.

For example, in a disc drive apparatus that performs recording/reproduction on an optical disc such as a CD (Compact Disc) and a DVD (Digital Versatile Disc) in related art, laser light for the recording/reproduction is used for the position control such as the tracking servo. That is, in the disc drive apparatus in related art, the recording/reproduction and the position control are concurrently performed by the irradiation of a single type of common laser light.

In the optical disc in related art, the recording/reproducing and the position control can be performed only by the single laser light irradiation as described above, because the recording layer has a clear threshold value of a recording power.

However, the way for the optical disc in related art is not applied to the hologram recording medium. Specifically, as the recording material of the hologram recording medium, a photopolymer is dominant at present, but the photopolymer does not have a clear threshold value of a recording power. That is, change characteristics from a monomer to a polymer largely depend not on a power of the irradiation light, but on the wavelength thereof. Therefore, even if the laser light is irradiated with a lower power like the optical disc in related art, the monomer may change into a polymer, with the result that recording characteristics of a portion where the change has occurred may be deteriorated.

For this reason, in this embodiment, the additional laser light whose wavelength is different from that of the laser light for the recording/reproduction is used for performing various position control actions.

[Structure of Recording/Reproducing Apparatus]

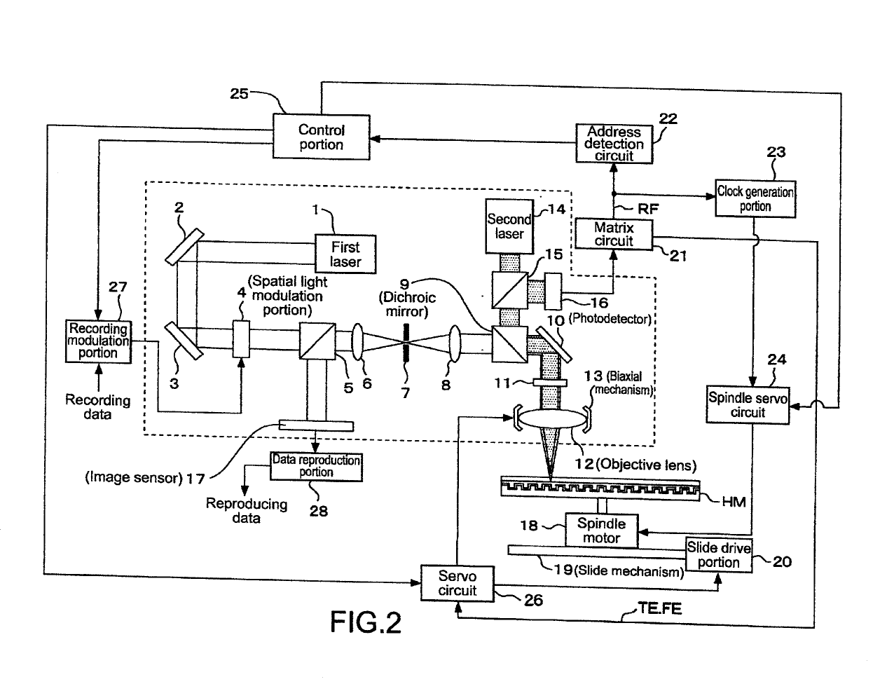

Next, a structure of the recording/reproducing apparatus for performing recording/reproduction on the above-described hologram recording medium HM of this embodiment will be described with reference to a block diagram of FIG. 2.

The recording/reproducing apparatus of this embodiment shown in FIG. 2 has a structure compatible with a so-called coaxial system as a hologram recording/reproducing system. Specifically, signal light and reference light are coaxially disposed and emitted to the hologram recording medium HM, to record data with interference fringes. For reproduction, the hologram recording medium HM is irradiated with the reference light, to thereby obtain a reproduction image of the data recorded with the interference fringes.

In FIG. 2, the recording/reproducing apparatus includes a medium holding portion (not shown) for holding the hologram recording medium HM. When the hologram recording medium HM is loaded in the recording/reproducing apparatus, the medium holding portion holds the hologram recording medium HM so that the hologram recording medium can be rotated and driven by a spindle motor 18. In the recording/reproducing apparatus, the hologram recording medium HM thus rotated and driven is irradiated with the first laser light emitted from the first laser 1, to thereby perform recording/reproduction of a hologram page.

Here, the hologram page refers to a unit of data that can be recorded by a single irradiation of the signal light, and is a minimum unit for write/read with respect to the hologram recording medium HM.

The first laser 1 is a laser diode with an external resonator or the like, and a wavelength of laser light thereof is 410 nm, for example.

The first laser light emitted from the first laser 1 enters a spatial light modulation portion 4 through mirrors 2 and 3 in this order.

The spatial light modulation portion 4 performs spatial light modulation on the incident light. In this example, the spatial light modulation portion 4 performs spatial light intensity modulation (hereinafter, also simply referred to as intensity modulation) and spatial light phase modulation (hereinafter, also simply referred to as phase modulation) so as to make the reproduction through the coherent addition possible.

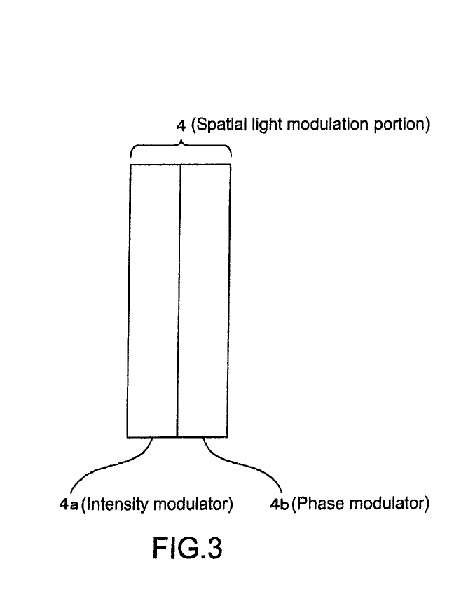

FIG. 3 is a diagram showing a structure of the spatial light modulation portion 4 capable of performing the intensity modulation and the phase modulation.

As shown in FIG. 3, the spatial light modulation portion 4 includes an intensity modulator 4a for performing spatial light intensity modulation on incident light and a phase modulator 4b for performing spatial light phase modulation thereon. The intensity modulator 4a and the phase modulator 4b are each formed of a transmissive liquid crystal panel.

The intensity modulator 4a performs the intensity modulation on the incident light by changing a transmissivity on a pixel basis based on a drive signal from a recording modulation portion 27 (described later).

The phase modulator 4b performs the phase modulation on the incident light on the pixel basis based on a drive signal from the recording modulation portion 27.

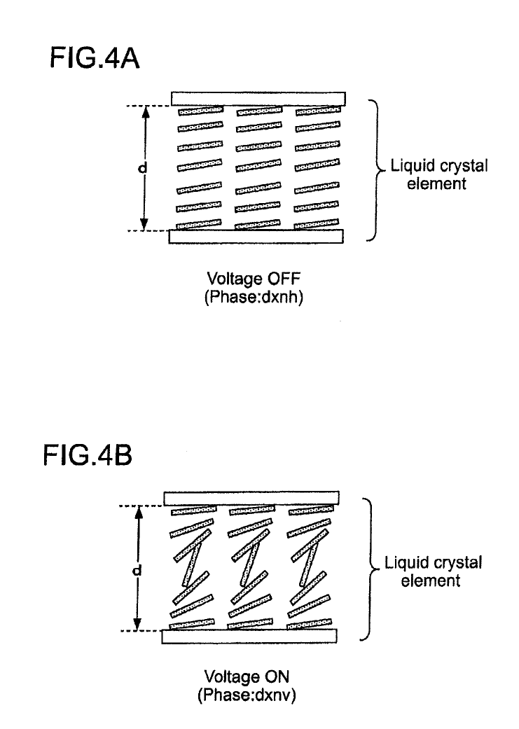

Here, a liquid crystal panel that is capable of performing the phase modulation on the pixel basis and serves as the phase modulator 4b can be materialized by structuring an inner liquid crystal element based on an idea as shown in FIG. 4.

FIG. 4A is a diagram showing liquid crystal molecules in a state where a drive voltage is not applied to the liquid crystal element in the liquid crystal panel (i.e., an off state of the drive voltage). FIG. 4B is a diagram showing the liquid crystal molecules in a state where the drive voltage is applied to the liquid crystal element at a predetermined level (i.e., an on state of the drive voltage).

The liquid crystal molecules are horizontally oriented in the off state of the drive voltage as shown in FIG. 4A, and are changed to be vertically oriented in the on state thereof as shown in FIG. 4B.

In this case, a phase variation given in the off state of the drive voltage is expressed as “d*nh” and a phase variation given in the on state of the drive voltage is expressed as “d*nv”, where n represents a refractive index of the liquid crystal element, nh represents a refractive index thereof in a case of horizontal orientation, nv represents a refractive index thereof in a case of vertical orientation, and d represents a thickness thereof. Accordingly, a phase difference Δnd that can be given by an on/off operation of the drive voltage is expressed as follows.

Δnd=d*nh−d*nv

The above relational expression reveals that the thickness d of the liquid crystal element only have to be adjusted for giving a required phase difference on the pixel basis.

In the phase modulator 4b of this embodiment, the thickness d of the liquid crystal element is adjusted, to thereby establish Δnd=n, for example. That is, by switching on/off of the drive voltage on the pixel basis, the light phase modulation using two values of “0” and “n” can be performed.

Further, the fact that the phase modulation by “0” and “n” can be performed by switching the drive voltages between on (at the predetermined level) and off as described above means that the phases can be modulated from “0” to “n” step by step by controlling the drive voltage stepwise up to the predetermined level. For example, assuming that a drive voltage level is set to be half the predetermined level, the phase modulation by “n/2” can be performed.

As shown in FIG. 3, the spatial light modulation portion 4 is integrally constituted of the intensity modulator 4a and the phase modulator 4b. The phase modulator 4b is capable of performing variable phase modulation on the pixel basis as described above. Specifically, pixels of the intensity modulator 4a and pixels of the phase modulator 4b are positioned so as to correspond to each other in a one-to-one positional relationship, and thus the intensity modulator 4a and the phase modulator 4b are integrally formed.

With this structure, with respect to the signal light and the reference light transmitted through the intensity modulator 4a, the spatial light phase modulation can be performed with completely the same phase modulation pattern on the pixel basis.

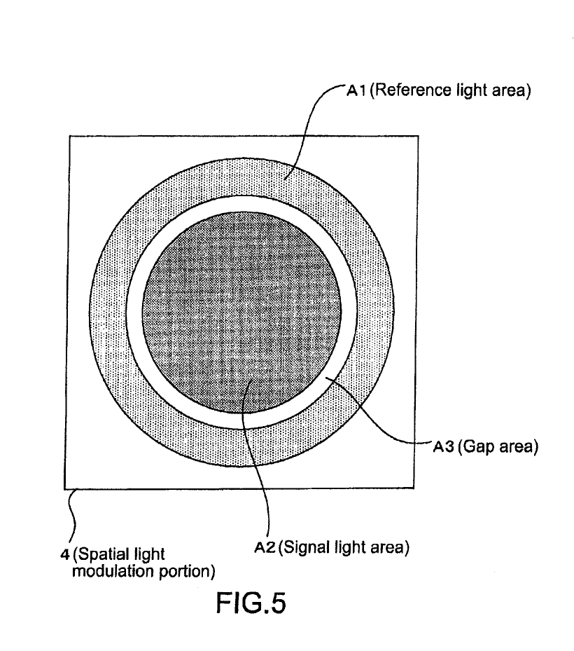

For the spatial light modulation portion 4 (intensity modulator 4a and phase modulator 4b), a reference light area A1, a signal light area A2, and a gap area A3 are defined as shown in FIG. 5. Specifically, a predetermined circular area (pixel range) including a center portion of the spatial light modulation portion 4 is defined as the signal light area A2 as shown in FIG. 5. In an outer peripheral portion of the signal light area A2, the gap area A3 and the reference light area A1 are defined in this order toward the outside. The reference light area A1 has a ring shape and is concentric with the signal light area A2.

It should be noted that the gap area A3 is defined as an area for preventing the reference light from entering the signal light area A2 to become a noise.

Let us get back to the description with reference to FIG. 2.

The recording modulation portion 27 performs drive control to cause the intensity modulator 4a and the phase modulator 4b of the spatial light modulation portion 4 to perform the intensity modulation and the phase modulation with respect to the first laser light, respectively.

Specifically, at the time of recording, the recording modulation portion 27 generates an on/off pattern (pattern of “0” and “1”) according to recording data to be supplied, as a voltage pattern to be applied to the pixels in the signal light area A2 of the intensity modulator 4a. Then, the recording modulation portion 27 combines the on/off pattern thus generated, a predetermined on/off pattern to be given to the pixels in the reference light area A1, and a pattern in which all pixels in the gap area A3 and outside the reference light area A1 are off, to generate the drive signal for all effective pixels of the intensity modulator 4a and supply the drive signal to the intensity modulator 4a. Based on the drive signal, the intensity modulator 4a performs spatial light intensity modulation, with the result that the signal light and the reference light can be obtained.

Further, at the time of recording, the recording modulation portion 27 performs drive control on the phase modulator 4b, in addition to the drive control on the intensity modulator 4a. Specifically, at the time of recording, the recording modulation portion 27 combines a predetermined random on/off pattern given to the pixels in the signal light area A2 of the phase modulator 4b, a predetermined on/off pattern to be given to the pixels in the reference light area A1, and a pattern in which all pixels in the gap area A3 and outside the reference light area A1 are off, to generate the drive signal for all effective pixels of the phase modulator 4b, and supply the drive signal to the phase modulator 4b. Based on the drive signal, the phase modulator 4b performs the spatial light phase modulation, with the result that the signal light obtained from the intensity modulator 4a is given a random phase pattern by “0” and “n”, and the reference light is given a predetermined phase pattern by “0” and “n”.

It should be noted that the recording modulation portion 27 drives the intensity modulator 4a so that the signal light with the intensity patterns different for each predetermined unit of recording data to be input is sequentially generated. With this structure, the data is sequentially recorded on the hologram recording medium HM on the hologram-page basis.

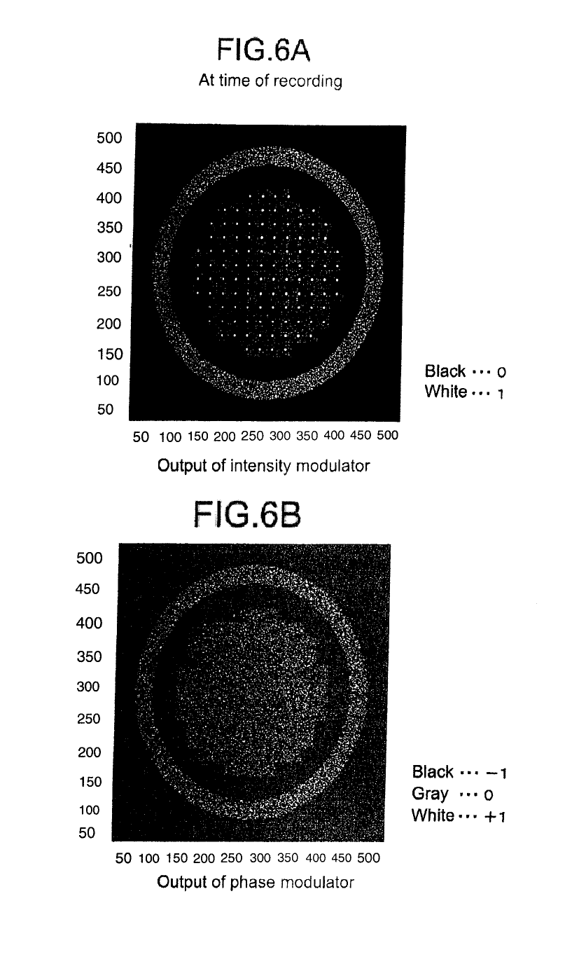

To make sure, with reference to FIG. 6, a description will be given on the signal light and the reference light generated through the intensity modulation and the phase modulation at the time of recording as described above.

FIG. 6A is a diagram showing output light from the intensity modulator 4a at the time of recording, and FIG. 6B is a diagram showing output light from the phase modulator 4b at the time of recording. In FIGS. 6A and 6B, color densities represent a magnitude relation of output light amplitudes. Specifically, a change in color from black to white represents a change in amplitude from “0” to “1” in FIG. 6A, and a change in color from black, through gray, to white represents a change in amplitude from “−1”, through “0”, to “1 (+1)” in FIG. 6B.

First, as described above, the intensity modulator 4a performs modulation on the incident light with the intensity of “0” or “1”. Accordingly, the output light from the intensity modulator 4a contains light having the amplitude of “0” or “1”, as shown in FIG. 6A.

On the other hand, as shown in FIG. 6B, the phase modulator 4b outputs light in which pixels having the amplitude of “1” output from the intensity modulator 4a are subjected to the phase modulation by “n”, and which has the amplitude of “−1”. Accordingly, the output light from the phase modulator 4b contains light having three amplitudes of “−1”, “0”, and “1”.

In should be noted that the “amplitude” herein refers to a light wavefront amplitude. Therefore, when the phase modulator 4b performs the phase modulation by “n” (180 degrees) on light that has been subjected to the intensity modulation by the intensity modulator 4a with the intensity of “1” and thus has the amplitude of “1”, the amplitude becomes “−1”.

In addition, with reference to FIG. 2, the recording modulation portion 27 performs, at the time of reproduction, the drive control on the spatial light modulation portion 4 so as to generate light for reproducing data recorded on the hologram recording medium HM.

Specifically, at the time of reproduction, the recording modulation portion 27 performs the drive control for generating the reference light and coherent light (described later) in the signal light area A2.

It should be noted that, for convenience of the description, an operation of generating the reference light and the coherent light at the time of reproduction will be described later.

The output light from the spatial light modulation portion 4 passes through a polarization beam splitter 5, and then enters a dichroic mirror 9 via a relay lens portion constituted of a relay lens 6, an aperture 7, and a relay lens 8.

The dichroic mirror 9 has such wavelength selectivity that the dichroic mirror 9 causes the first laser light to pass therethrough and reflects light (second laser light) emitted from the second laser 14. Thus, the first laser light traveling through the relay lens portion passes through the dichroic mirror 9 and is reflected by a mirror 10 as shown in FIG. 2. The first laser light reflected by the mirror 10 passes through a quarter-wave plate 11 and an objective lens 12 held by a biaxial mechanism 13. Then, the hologram recording medium HM is irradiated with the first laser light.

The biaxial mechanism 13 holds the objective lens 12 so that the objective lens 12 can be displaced in a focus direction and a tracking direction. Here, the focus direction refers to a direction of getting close to/away from the hologram recording medium HM, and the tracking direction refers to a radius direction of the hologram recording medium HM (direction perpendicular to the focus direction).

The biaxial mechanism 13 includes a focus coil for driving the objective lens 12 in the focus direction and a tracking coil for driving the same in the tracking direction, and performs position control on the objective lens 12 in response to a focus drive signal and a tracking drive signal from a servo circuit 26 described later.

As described above, the hologram recording medium HM is irradiated with the first laser light that has passed through the spatial light modulation portion 4 via the objective lens 12. By performing the spatial light modulation by the spatial light modulation portion 4 described above, the signal light and the reference light are generated based on the first laser light at the time of recording. That is, at the time of recording, the hologram recording medium HM is irradiated with the signal light and the reference light. The hologram recording medium HM is irradiated with the signal light and the reference light in this way, to thereby record data on the recording layer HM-B shown in FIG. 1 with the interference fringes of the signal light and the reference light.

In addition, at the time of reproduction, the spatial light modulation portion 4 generates the reference light (and the coherent light) and the hologram recording medium HM is irradiated with the reference light through the above-described optical path, with the result that the diffraction light (reproduction light, i.e., reproduction image) corresponding to the interference fringes can be obtained. In the hologram recording medium HM, the diffraction light is reflected by the first reflection film HM-D shown in FIG. 1. Accordingly, the diffraction light is caused to return to the recording/reproducing apparatus as the reflected light from the hologram recording medium HM.

The diffraction light (reproduction light) as the reflected light is made parallel through the objective lens 12, and then passes through the dichroic mirror 9 via the quarter-wave plate 11 and the mirror 10. The reproduction light that has passed through the dichroic mirror 9 then enters the polarization beam splitter 5 via the relay lens portion.

The polarization beam splitter 5 reflects the incident reproduction light. The reflection light that has been reflected by the polarization beam splitter 5 enters an image sensor 17 as shown in FIG. 2.

The image sensor 17 includes a CCD (Charge Coupled Device) sensor, a CMOS (Complementary Metal Oxide Semiconductor) sensor, and the like. The image sensor 17 receives the reproduction light from the hologram recording medium HM introduced as described above, and converts the light into an electrical signal to obtain an image signal. The image signal thus obtained is based on the on/off pattern (i.e., recording data pattern) given to the signal light at the time of recording. That is, the image signal obtained by the image sensor 17 in this way corresponds to a read signal of data recorded on the hologram recording medium HM.

A data reproduction portion 28 distinguishes data between “0” and “1” for each value in the pixel unit in the signal light area A2 of the spatial light modulation portion 4 that is contained in the image signal obtained by the image sensor 17, to reproduce data recorded on the hologram recording medium HM.

It should be noted that the content of a reproduction signal processing by the data reproduction portion 28 will be described later.

In addition, the recording/reproducing apparatus shown in FIG. 2 is provided with an optical system for performing various position control actions for recording/reproducing operations executed using the first laser light as described above. Specifically, the second laser 14, a polarization beam splitter 15, and a photodetector 16 are provided.

The second laser 14 emits laser light whose wavelength is different from that of the first laser light. In this case, for example, the second laser 14 outputs laser light having the wavelength of 650 nm, which has almost no sensitivity to the recording layer HM-B of the hologram recording medium HM.

The second laser light emitted from the second laser 14 passes through the polarization beam splitter 15, is then reflected by the dichroic mirror 9, and guided to the mirror 10. After that, the hologram recording medium HM is irradiated with the second laser light traveling through the same path as in the case of the first laser light described above.

It should be noted that, as can be seen from the above, the dichroic mirror 9 has a function of irradiating the hologram recording medium HM with the first laser light and the second laser light with the optical axes of theirs being coincided with each other.

As described above with reference to FIG. 1, in the hologram recording medium HM, the second laser light thus irradiated having a wavelength of 650 nm passes through the first reflection film HM-D, and is reflected by the second reflection film HM-F formed on a lower surface side thereof. Accordingly, reflection light that is based on the convex-concave pattern as the pit rows (recording track) formed on the substrate HM-G can be obtained.

The reflection light from the second reflection film HM-F also enters the dichroic mirror 9 via the objective lens 12, the quarter-wave plate 11, and the mirror 10, as in the case of the first laser light.

The dichroic mirror 9 reflects the reflection light of the second laser light from the hologram recording medium HM, and the reflection light is guided to the polarization beam splitter 15. The polarization beam splitter 15 reflects the reflection light of the second laser light from the hologram recording medium HM, and the light is guided to the photodetector 16.

The photodetector 16 includes a plurality of light-receiving elements. The photodetector 16 receives the reflection light of the second laser light from the hologram recording medium HM guided as described above, converts the light received into an electrical signal, and supplies the electrical signal to a matrix circuit 21.

The matrix circuit 21 includes a matrix operation/amplification circuit and the like for an output signal from the plurality of light-receiving elements of the photodetector 16, and generates a necessary signal through a matrix operation processing.

Generated are, for example, a signal corresponding to a reproduction signal for the pit row formed on the hologram recording medium HM (reproduction signal RF), and a tracking error signal TE and a focus error signal FE for the servo control.

The reproduction signal RF output from the matrix circuit 21 is supplied to an address detection circuit 22 and a clock generation portion 23. Further, the focus error signal FE and the tracking error signal TE are supplied to the servo circuit 26.

The clock generation portion 23 performs a PLL processing based on the reproduction signal RF, to generate a reproduction clock. The reproduction clock is supplied to a spindle servo circuit 24. In addition, the reproduction clock is supplied as an operation clock for required portions (not shown).

The spindle servo circuit 24 performs rotation control on the spindle motor 18 described above.

The spindle servo circuit 24 obtains the reproduction clock as current rotation speed information of the spindle motor 18, and compares the current rotation speed information with predetermined reference speed information, to thereby generate a spindle error signal.

The spindle servo circuit 24 performs the rotation control on the spindle motor 18 based on the spindle drive signal generated according to the spindle error signal.

Further, the spindle servo circuit 24 generates a spindle drive signal based on an instruction from a control portion 25 (described later), and performs control of start, stop, acceleration, deceleration, and a rotational direction of the spindle motor 18.

The address detection circuit 22 detects address information based on the reproduction signal RF. The address information detected by the address detection circuit 22 is supplied to the control portion 25.

The servo circuit 26 generates various servo signals on focus, tracking, and sled based on the focus error signal FE and the tracking error signal TE from the matrix circuit 21, to perform a servo operation.

Specifically, the focus servo signal and the tacking servo signal are generated based on the focus error signal FE and the tracking error signal TE, and those servo signals thus generated are supplied as drive signals (focus drive signal and tracking drive signal) for the biaxial mechanism 13. As a result, the focus coil and the tracking coil of the biaxial mechanism 13 are driven and controlled using the drive signals based on the servo signals. Thus, a tracking servo loop and a focus servo loop are formed by the photodetector 16, the matrix circuit 21, the servo circuit 26, and the biaxial mechanism 13.

Further, the servo circuit 26 turns off the tracking servo loop according to a track jump instruction from the control portion 25 and outputs a jump pulse as the tracking drive signal, to thereby execute a track jump operation.

Furthermore, the servo circuit 26 drives a slide mechanism 19 to slide by a slide drive portion 20 shown in FIG. 2, based on a sled error signal obtained as a low-frequency component of the tracking error signal TE and seek operation control by the control portion 25.

The slide mechanism 19 holds the spindle motor 18 slidably in the tracking direction. By providing the slide mechanism 19, the hologram recording medium HM driven to rotate by the spindle motor 18 can be displaced in the tracking direction.

The slide drive portion 20 includes a motor for driving the slide mechanism 19. Based on a drive force of the motor, the slide mechanism 19 slides the spindle motor 18.

The overall operation of the recording/reproducing apparatus including the above-described servo system is controlled by the control portion 25.

The control portion 25 is formed of a microcomputer including a ROM (Read Only Memory), a RAM (Random Access Memory), a CPU (Central Processing Unit), and the like.

The control portion 25 performs control for reproducing data recorded on the hologram recording medium HM, for example. Specifically, when reproducing certain data recorded on the hologram recording medium HM, the control portion 25 specifies a target address to execute seek operation control. Specifically, the control portion 25 indicates the target address with respect to the servo circuit 26 and causes the servo circuit 26 to execute an access operation to an addressed position indicated as the target. In addition to this, the control portion 25 instructs the recording modulation portion 27 to execute an operation for reproduction (described later), to generate the reference light and the coherent light by the spatial light modulation portion 4.

Further, for example, when recording data on a certain position on the hologram recording medium HM, the control portion 25 indicates a target address to the servo circuit 26 and causes the servo circuit 26 to execute an access operation to an addressed position as the target, and instructs the recording modulation portion 27 to start drive control on the spatial light modulation portion 4 based on the recorded data.

As described above, the first laser light and the second laser light are coaxially disposed by the dichroic mirror 9, and the hologram recording medium HM is irradiated with them via the shared objective lens 12.

Therefore, by performing various position control actions (e.g., tracking servo control/focus servo control and access control) based on the reflection light from the second laser light as described above, the same position control is performed with the first laser light.

### [Reproduction Through Coherent Addition]

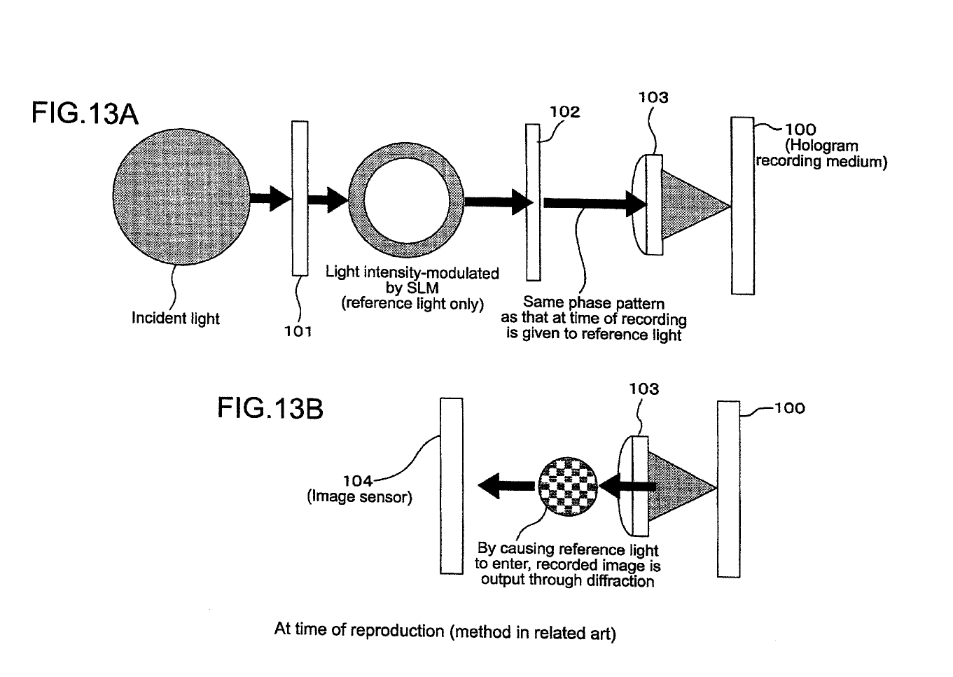

In a case where the past reproduction method of reading data through the irradiation with only the reference light as shown in FIG. 13 is used for reproducing data from the hologram recording medium HM, the phase information recorded on the hologram recording medium HM cannot be read. This is because the hologram recording/reproducing system has nonlinearity.

The nonlinearity of the hologram recording/reproducing system will be described. First, in an optical system with a typical hologram recording/reproducing system including the structure shown in FIG. 2, an SLM (spatial light modulation portion), an objective lens, a medium, an eye lens, and an image sensor are disposed while each being apart by a focal length of the lens, thus forming a structure based on a 4f optical system. This is a so-called Fourier transform hologram.

In the structure of the Fourier transform hologram as described above, a series of operations of the recording/reproducing system can be regarded as follows. That is, a recorded data pattern of the SLM is subjected to a Fourier transform to be projected on the hologram recording medium, and a read signal (reproduction image) from the medium is subjected to an inverse Fourier transform to be projected on the image sensor. The image sensor detects a light intensity as an absolute value (square value) of a light wave-front amplitude input thereto.

Due to the nonlinearity that resides in the hologram recording/reproducing system as described above, the irradiation with only the reference light at the time of reproduction as in the related art does not make it possible to appropriately read the phase information recorded.

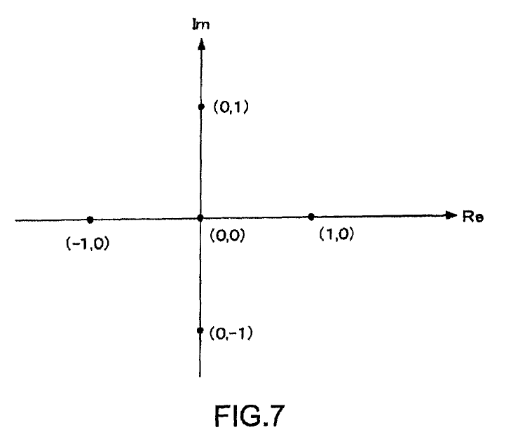

This will be explained with reference to FIG. 7.

FIG. 7 is a diagram showing a representation in which a signal value recorded on the hologram recording medium HM with a combination of light having an amplitude of “1” and a required phase is expressed, with an ordinate axis (x axis) being a real-number axis Re and a longitudinal axis (y axis) being an imaginary-number axis Im.

The real-number axis Re represents phases “0” and “Π” with the coordinate origin being a boundary point, and the imaginary-number axis Im represents phases “Π/2” and “3Π/2” with the coordinate origin being a boundary point.

A signal value recorded after combining light having a certain intensity (amplitude) with the phases can be represented as (x, y), where a value on the real-number axis Re is expressed as x and a value on the imaginary-number axis Im is expressed as y. Specifically, a signal value recorded with a combination of light having an amplitude of “1” and a phase “0” is (1, 0). Further, a signal value recorded with a combination of light having an amplitude of “1” and a phase “Π” is (−1, 0). In addition, a signal value recorded with a combination of light having an amplitude of “1” and a phase “Π/2” is (0, 1), and a signal value recorded with a combination of light having an amplitude of “1” and a phase ““3Π/2” is (0, −1).

In a case where the signal values expressed by (x, y) as described above are read through irradiation with only the reference light, the light intensity detected by the image sensor 17 is expressed as a distance from the origin (0, 0). Therefore, regardless of the phases to be combined with the light having a certain amplitude (intensity) (of “1” in this case) for recording, the image sensor 17 detects the light intensity of “1” only.

In view of the above, in the recording/reproducing apparatus according to this embodiment, the coherent light (DC light) that has a uniform amplitude and phase and that has passed through the signal light area A2 is also irradiated together with the reference light at the time of reproduction.

When irradiation with the coherent light generated after having passed through the signal light area A2 is performed as described above, the amplitude of the coherent light can be added to the reproduction light obtained through irradiation of the reference light. Specifically, when the amplitude of the coherent light of “1” can be added, a signal having an amplitude of “−1” recorded with the phase of “Π” becomes “−1”+“1”. That is, the image sensor 17 can detect the light intensity of 0 (=−1+1). Similarly, a signal having an amplitude of “1” recorded with the phase of “1” can be detected as a signal whose light intensity is “2” (=1+1), and a signal having an amplitude of “0” can be detected as a signal whose light intensity is “1” (=0+1).

The coherent light is added to the reproduction light to be read as described above, with the result that the information of the amplitudes of “−1”, “0”, and “1” recorded with a combination of the amplitudes of “0” and “1” obtained through the intensity modulation and the phases of “0” and “Π” can be detected so that the light intensities of “0”, “1”, and “2” can be distinguished from one another.

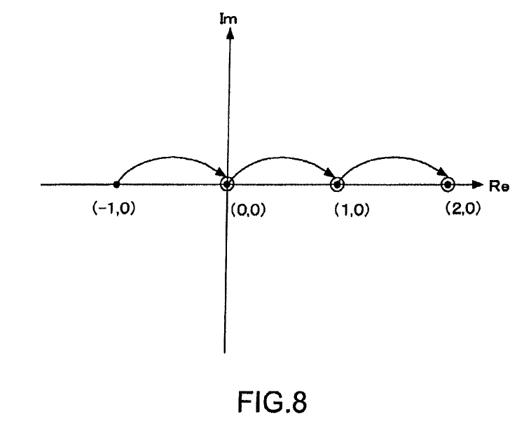

The above-described addition and reading principle of the coherent light is represented as shown in FIG. 8 when using the real-number axis Re and the imaginary-number axis Im of FIG. 7.

As shown in FIG. 8, the fact that the coherent light having the amplitude of “1” is added to the reproduction light as described above means that the amplitude “1” is added to the signal values to shift the coordinates thereof by “1” toward the phase of “0” (in a positive direction of the real-number axis Re).

Accordingly, as shown in FIG. 8, the signal value (−1, 0) recorded with a combination of the amplitude of “1” and the phase of “Π” is shifted to (0, 0). Further, the signal value (1, 0) recorded with a combination of the amplitude of “1” and the phase “0” is shifted to (2, 0), and the signal value (0, 0) recorded with the amplitude of “0” is shifted to (1, 0). Thus, the light intensities detected by the image sensor 17 for the signal values are “0”, “1”, and “2”, respectively, to thereby obtain the above-mentioned result.

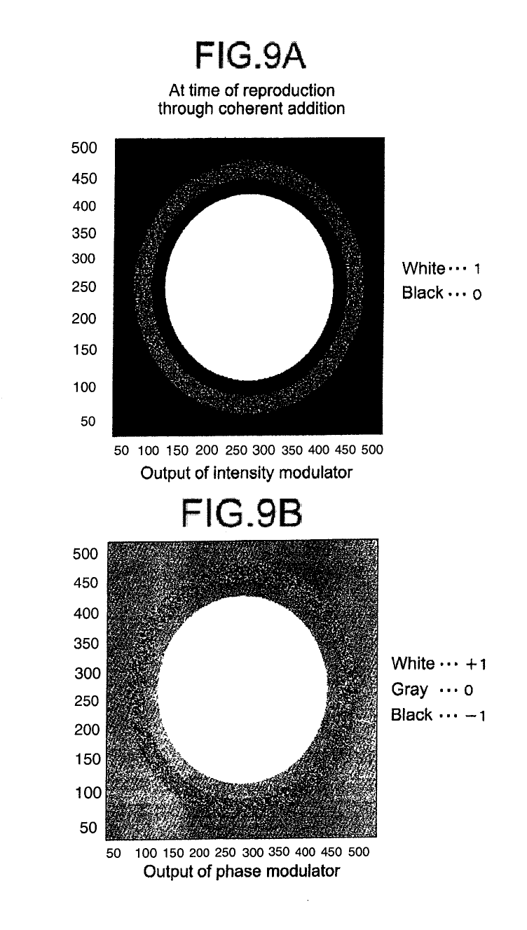

A specific example of a spatial light modulation at the time of reproduction for the purpose of implementing a reading operation through the coherent addition will be described with reference to FIG. 9.

FIG. 9A shows output light from the intensity modulator 4a at the time of reproduction, and FIG. 9B shows output light from the phase modulator 4b at the time of reproduction. In FIG. 9, as in FIG. 6, color densities represent a magnitude relation of output light amplitudes. Specifically, a change in color from black to white represents a change in amplitude from “0” to “1” in FIG. 9A, and a change in color from black, through gray, to white represents a change in amplitude from “−1”, through “0”, to “1” in FIG. 9B.

First, as can be seen from FIG. 9A, in the intensity modulation at the time of reproduction in this case, the reference light is generated and the intensity of “1” is given to the signal light area A2. That is, by causing the incident light on the signal light area A2 to pass therethrough, light to be the coherent light is generated.

It should be noted that the intensity modulation pattern of the reference light generated at the time of reproduction is the same as that at the time of recording.

Further, in FIG. 9B, in the phase modulation at the time of reproduction, the reference light generated through the intensity modulation is given a predetermined phase pattern that is the same as that at the time of recording.

In a case of performing phase multiplexing recording in which the predetermined phase modulation pattern is given to the reference light at the time of recording as in this example, the reference light at the time of reproduction and the reference light at the time of recording are caused to have the same pattern as described above, with the result that the recorded signal can be read accurately.

Here, in this specification, a pixel in the reference light area A1 to which the phase of “0” is imparted when the phase modulation pattern is given at the time of recording as described above is referred to as a “reference pixel”. A “reference phase of the reference light” indicates a phase of light through the reference pixel in the reference light area A1.

In view of this, in a case where the reference light at the time of reproduction and the reference light at the time of recording are set to have the same phase modulation pattern as described above, the reference phase of the reference light at the time of reproduction has the same value of “0”.

In the phase modulation at the time of reproduction in this case, a phase obtained by shifting the reference phase of the reference light by Π/2 (90 degrees) is given to light to be the coherent light obtained by causing the light to pass through the signal light area A2 as described above. Specifically, the reference phase of the reference light is “0” in this case as described above, and therefore the phase in the signal light area A2 is set to “Π/2”.

Here, based on the above description, in the reproduction method of this example in which reading through addition of the coherent light is performed, it is necessary to add, to the reproduction light, the coherent light as a component having the amplitude of “1”, for example. To realize this, it is only necessary to set the phase of the coherent light so as to have the same phase as a part which has the same amplitude of “1” in the reproduction light and on which the phase “0” is recorded.

As can be understood from the above description, for performing reading through addition of the coherent light, the phase of the coherent light to be added should be set with the phase of the part in the reproduction light on which the amplitude of “1”=the phase “0” is recorded being a reference. In view of this, the phase of the part in the reproduction light on which the phase “0” is recorded is referred to as a “reference phase of the reproduction light” in this specification.

In the above, although the coherent light is set to have a phase difference of “Π/2” with respect to the reference phase of the reference light, the reference phase of the reference light is “0” in this case, and therefore the reference phase (phase of the part on which the phase “0” is recorded) of the reproduction light obtained through the irradiation with the reference light can also be “0”. That is, it can be thought that the phase to be set for the coherent light should be “0” that is the same as the reference phase of the reproduction light.

In actuality, however, in the case where the phase of the coherent light is set to “0”, the phase of the coherent light and the reference phase of the reproduction light cannot be the same. The reason is as follows: in the hologram recording/reproducing system, when the reproduction light is obtained through irradiation with the reference light, the phase of the reproduction light is shifted from the phase of the recording signal by Π/2, as described in “Coupled wave theory for thick hologram grating” (written by Kogelnik, H, Bell System Technical Journal, 48, 2909-47). In other words, to cope with the phase shifting of the reproduction light by Π/2, the phase of the coherent light to be added is shifted by Π/2.

Here, the relationship of the phases will be explained.

First, suppose that the phase (reference phase) of the part in the recording signal on which the phase of “0” is recorded in a case of recording with the combination of the phases “0” and “Π” through irradiation with the reference light to which the predetermined phase modulation pattern is imparted as described above is “0”.

In consideration of the above, irradiation with the reference light to which the same phase modulation pattern as that at the time of recording is imparted is performed at the time of reproduction, to obtain the reproduction light. It can be simply predicted that the irradiation with the reference light having the same phase modulation pattern as that at the time of recording may bring no change in the reference phase of the reproduction light obtained according to the recording signal, meaning that the reference phase remains “0”. In actuality, however, the phase of the reproduction light is obtained by shifting the phase of the recording signal by “Π/2” as described above. In response to this, the phase of the coherent light is set to “Π/2” as described above. As a result, the reference phase of the reproduction light (Π/2) and the phase of the coherent light (Π/2) can be coincided with each other.

In this case, regarding the relationship between the phases of the reproduction light and the reference light, the reference phase of the reference light is “0”, and the reference phase of the reproduction light is “Π/2”. Accordingly, it can be understood that the reference phase of the reproduction light is obtained by shifting the reference phase of the reference light by Π/2. Therefore, the coherent light only has to be set to have the phase difference of “Π/2” with respect to the reference phase of the reference light.

Subsequently, a description will be given on operations carried out by the recording modulation portion 27 and the spatial light modulation portion 4 shown in FIG. 2 in order to implement the reproduction operation using the coherent addition described above.

First, at the time of reproduction, the recording modulation portion 27 performs a drive control operation of the intensity modulator 4a of the spatial light modulation portion 4 as follows.

That is, an on/off pattern that is the same as that at the time of recording is given to the pixel in the reference light area A1, and a pattern in which all pixels in the signal light area A2 are turned on and all pixels in the gap area A3 and outside the reference light area A1 are turned off is generated. Based on the patterns thus generated, the drive signal for all the effective pixels of the intensity modulator 4a is generated and given to the intensity modulator 4a.

Further, the recording modulation portion 27 performs control on the phase modulator 4b at the time of reproduction as follows.

That is, the reference light area A1 is caused to have the phases of “0” and “Π” (on/off (“0” and “1”) of the drive voltage) that are the same as that at the time of recording. In addition, a pattern in which the signal light area A2 has a value corresponding to the phase of “Π/2”, i.e., “½”, and the gap area A3 and the part outside the reference light area A1 have “0” is generated. Based on the patterns thus generated, a drive signal for all the effective pixels of the phase modulator 4b is generated and given to the phase modulator 4b.

By performing the above-described modulation operations of the spatial light modulation portion 4 based on the control by the recording modulation portion 27, at the time of reproduction, the reference light having the intensity and the phase modulation pattern that are the same as those at the time of recording as described with reference to FIG. 9b, and the coherent light having the intensity of “1” and the phase difference of “Π/2” with respect to the reference phase in the reference light can be obtained.

Here, at the time of reproduction, in response to the irradiation of the reference light and the coherent light, the image sensor 17 reads a component obtained by adding the reproduction light obtained from the hologram recording medium HM through the irradiation with the reference light and the coherent light caused to have the same phase as the reference phase of the reproduction light.

A read signal (image signal) obtained by the image sensor 17 is supplied to the data reproduction portion 28 shown in FIG. 2.

As described above, the data reproduction portion 28 discriminates data of “0” and “1” for each value on the pixel basis (data pixel basis) of the spatial light modulation portion 4, contained in the image signal obtained by the image sensor 17, and reproduces data that has been recorded on the hologram recording medium HM.

In this embodiment, through addition of the coherent light, values corresponding to the light intensities of “0”, “1”, and “2” are contained in the read signal obtained by the image sensor 17. Out of those, a pixel having a value corresponding to the light intensities of “0” or “2” has “1” as the recording data recorded thereon. Also, a pixel having a value corresponding to the light intensity of “1” has “0” as the recording data recorded thereon.

Accordingly, the data reproduction portion 28 judges the data pixel from which the value corresponding to the light intensity of “0” or “2” in the image signal from the image sensor 17 is detected as a bit “1”, and the data pixel from which the value corresponding to the light intensity of “1” is detected as a bit “0”. Through the data discrimination, the data of “0” and “1” recorded on the hologram recording medium HM can be appropriately judged.

It should be noted that, in the above description, a processing for specifying positions of the data pixels in the image signal obtained by the image sensor 17 is not particularly mentioned. For specifying the positions, a typical method in related art in which predetermined pattern data called sink is inserted in the recording data is used. In this case, the data reproduction portion 28 searches the image signal supplied from the image sensor 17 for a sink portion as the predetermined pattern, and performs the processing for specifying the positions of the data pixels based on a position of the sink portion thus detected.

The method of specifying the positions of the data pixels is not particularly limited herein, and an optimal method such as a method proposed in related art or a method to be proposed in the aftertime may be used as appropriate.

In addition, after the positions of the data pixels are specified, a processing for obtaining a value (amplitude value) for each data pixel is performed. In related art, for example, an interpolation processing is performed based on values of pixels around the specified data pixels and the amplitude values of the data pixels are calculated, to thereby obtain the values. This is a general method in a field of the image processing, and a bi-linear interpolation method, a cubic convolution method, a bicubic spline method, and the like are known. In addition, a nearest neighbor method in which a signal value having timing closest to the specified position is selected as an amplitude value of the data pixel without calculation is also proposed.

Various methods may be used for the processing of obtaining the amplitude value, and there is no particular limitation on the method herein.

[Formation of Gap Layer]

As described above, when the reproduction method through the coherent addition is used, not only the intensity information recorded on the hologram recording medium HM, but also the phase information can be read appropriately.

For reproducing data from the read signal obtained by the image sensor 17, in actuality, the processing for specifying the positions of the data pixels on the spatial light modulation portion 4 side and the processing for calculating the signal value through the interpolation processing based on the data pixel values are performed as described above.

Prior to those processings, a processing for suppressing interference between the values of pixels detected by the image sensor 17, i.e., inter-pixel interference is performed. However, by the past method of performing irradiation with only the reference light at the time of reproduction, it is difficult to represent the interference between the pixels (intersymbol interference) through a simple linear addition due to the above-mentioned nonlinearity problem. Therefore, it is extremely difficult to cause the signal processing for suppressing the inter-pixel interference to operate effectively. For this reason, it is extremely difficult to realistically implement the data reproduction by using the method in related art.

In contrast, when the reproduction method through the coherent addition is used, the nonlinearity problem that resides in the hologram recording/reproducing system is intended to be solved. Therefore, the signal processing for suppressing the inter-pixel interference as described above can be operated effectively, with the result that the data reproduction can be realistically implemented with more ease.

Further, when the reproduction method through the coherent addition is used, there are advantages in that a contrast of the reproduction image is expanded and an S/N is improved.

The improvement of the S/N may also greatly contribute to more realistic implementation of the data reproduction, for example.

Further, the fact that the phase information can be read, that is, information can be linearly read means that recording/reproduction of data of multiple values can also be implemented, in addition to the data of two values of “0” and “1”.

For example, because it is assumed that the data of two values of “0” and “1” are recorded/reproduced in the above description, the values of light intensities of “0”, “1”, and “2” detected are reproduced as two values of “0” and “1” eventually. At this time, however, when the reproduction processing is performed such that the values of “0”, “1”, and “2” are discriminated as different symbols, recording/reproduction can be performed using the three values. Alternatively, the phases to be combined are increased to “0”, “Π/2”, “Π”, “3Π/2”, and the like, with the result that the recording/reproduction of data of more multiple values can be performed.

In this way, the reproduction method through the coherent addition can provide excellent effects such that the data reproduction can be more realistically implemented and recording/reproduction of data of multiple values can be performed.

However, the coherent light is DC light that has uniform amplitude and phase. Therefore, when the reproduction method of irradiating the hologram recording medium HM with the reference light and the coherent light through the coherent addition is used, a light spot is formed in the hologram recording medium HM, which raises a problem of occurrence of a very strong peak. Therefore, this may cause corruption of recording data or give damage to the recording material at the time of reproduction.

In view of this, in this embodiment, the gap layer HM-C is formed in the hologram recording medium HM as shown in FIG. 1.

The gap layer HM-C is made of a material having a transmission property, such as a transparent resin. As can be seen from the description with reference to FIG. 1, the gap layer HM-C is provided between the recording layer HM-B on which the hologram is recorded and the first reflection film HM-D that reflects the irradiation light (first laser light) for recording/reproducing the hologram. The recording layer HM-B is positioned on the upper surface side of the gap layer HM-C, and the first reflection film HM-D is positioned on the lower surface side thereof. Thus, a focus point (focal point) of the irradiation light for recording/reproducing the hologram can be set apart from the recording layer HM-B by a distance corresponding to the thickness of the gap layer HM-C.

Therefore, in this case, the focus point of the first laser light is controlled along with the focus control on the second laser light using the second reflection film HM-F, and the first laser light is caused to focus on the first reflection film HM-D as shown in FIG. 1, for example, due to the focus control. If the gap layer HM-C is not provided, the recording layer HM-B comes closer to the first reflection film HM-D, and therefore the focus point of the first laser light comes closer to the recording layer HM-B by a distance corresponding to the thickness of the gap layer HM-C. As can be understood from this, the insertion of the gap layer HM-C can cause the irradiation light for recording/reproducing the hologram to defocus from the recording layer HM-B.

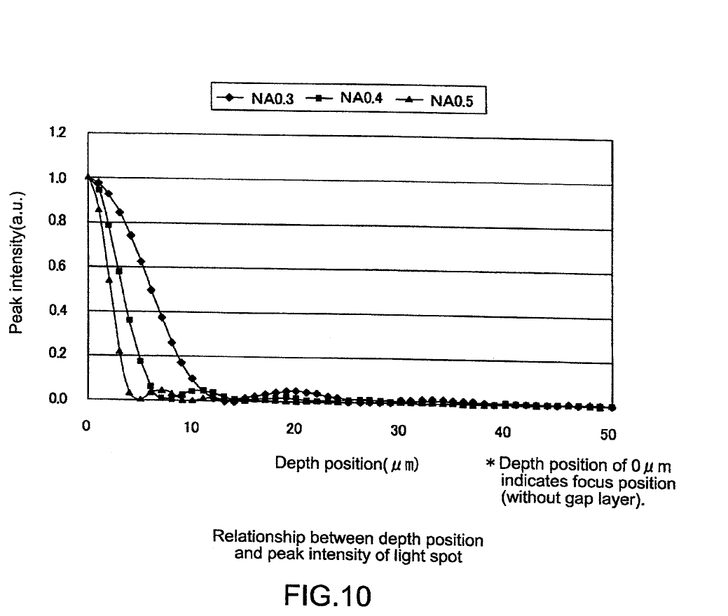

FIG. 10 is a graph showing a relationship between a depth position of the irradiation light and a peak intensity of a light spot, for explaining that the formation of the gap layer HM-C suppresses the peak intensity of the light spot.

FIG. 10 shows the relationship between the depth position and the peak intensity in a case where numeric apertures NA of the objective lens 12 are set to 0.3 (rhombic plot in FIG. 10), 0.4 (square plot), and 0.5 (triangular plot).

It should be noted that the depth position of 0 μm corresponds to a focal position (focus point), that is, the gap layer HM-C is not provided.

FIG. 10 reveals that a rate of change in peak intensity with respect to a change in depth position (the thickness of the gap layer HM-C) increases as the numerical aperture increases. For example, when NA is 0.5, the peak intensity becomes approximately 0 at the depth position of about 5 μm. Further, when NA is 0.4, the peak intensity becomes approximately 0 at the depth position of about 7 μm, and when NA is 0.3, the peak intensity becomes approximately 0 at the depth position of about 14 μm.

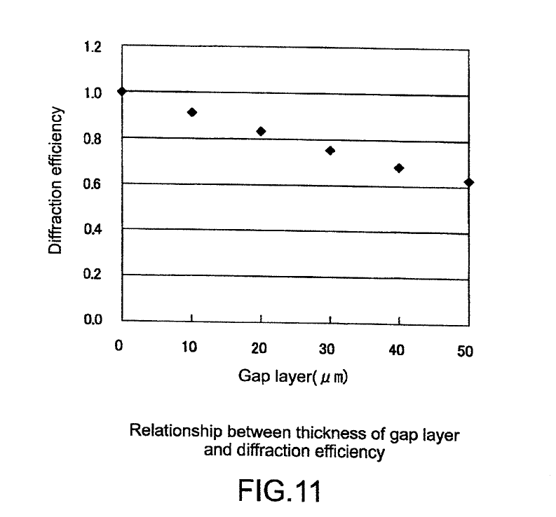

FIG. 11 is a graph showing a relationship between the thickness of the gap layer HM-C and a diffraction efficiency.

FIG. 11 reveals that the diffraction efficiency on which the amount of reproduction light depends gradually decreases as the thickness of the gap layer HM-C increases. Specifically, in this case, the diffraction efficiency becomes about 0.92, 0.82, 0.78, 0.68, and 0.62 when the thickness of the gap layer HM-C is 10 μm, 20 μm, 30 μm, 40 μm, and 50 μm, respectively.

It should be noted that FIG. 11 shows a result in a case of NA=0.6 as an example, but when the NA is further increased, the rate of change in diffraction efficiency with respect to the thickness of the gap layer HM-C becomes smaller, and when NA is further decreased, the rate of change becomes larger.

As can be understood from FIGS. 10 and 11, when the thickness of the gap layer HM-C is set larger, the peak intensity can be suppressed more strongly, but the diffraction efficiency is lowered. In contrast, when the thickness of the gap layer HM-C is set smaller, the diffraction efficiency can be enhanced, but the peak intensity cannot be suppressed satisfactorily.

Further, the peak intensity and the rate of change in diffraction efficiency with respect to the thickness of the gap layer HM-C as described above also depends on the NA value.

The thickness of the gap layer HM-C only has to be set to an optimal value based on an actual NA set value and a balance between the peak intensity and the diffraction efficiency as appropriate.

Here, an experiment shows that when the thickness of the gap layer HM-C is set to be at least smaller than 50 μm with respect to a possible NA range in actual use (e.g., about 0.4 to 0.8), the peak intensity of the light spot can be sufficiently suppressed (approximately “0”) and the diffraction efficiency acceptable in actual use can be secured.

More desirably, the thickness of the gap layer HM-C is set within the range of 10 to 20 μm, with the result that the diffraction efficiency acceptable in actual use can be secured and the peak intensity of the light spot can be sufficiently suppressed at the same time.

### MODIFIED EXAMPLE

The embodiment of the present invention is described above, but the present invention is not limited to the examples described above.

For example, the case where the recording track is formed along with the formation of the pit rows on the substrate HM-G is described above. Alternatively, the track may be formed with a groove (groove continuously formed). In this case, the address information and the clock information can be recorded using information on a cycle of meandering of the groove.

Alternatively, it is also possible to provide the groove with only a function of guiding the recording position of the hologram page without meandering, and additionally form a pit row for recording the address information and the clock information with the pit row and the groove being traveled side by side. In this case, an optical system is structured as follows: irradiation with the second laser light is performed so that at least two laser spots used for detecting the tracking error signal and the like for the groove and for reading the information on the pit row are formed, and a plurality of photodetectors for separately detecting reflection light from the groove and the pit row are provided thereto.

Further, the description is given above on the case where the various position control actions for recording/reproducing the hologram are performed through the position control using the light whose wavelength is different from that of the irradiation light for recording/reproducing the hologram in a shared manner. However, as in the case of the optical disc in related art, the various position control actions can be performed based only on the irradiation light for the recording/reproduction.

In this case, it is only necessary that the hologram recording medium has a structure in which the substrate HM-G is formed under the first reflection film HM-D without providing the second reflection film HM-F and the intermediate layer HM-E shown in FIG. 1 therebetween so that a convex-concave shape of the substrate HM-G is reflected on the first reflection film HM-D. Meanwhile, the apparatus only has to perform the focus servo based on the reflection light from the first reflection film HM-D obtained through irradiation with light for recording/reproducing the hologram.

Also in this case, the insertion of the gap layer HM-C can set the focus point (the first reflection film HM-D) and the recording layer HM-B apart, and can defocus the irradiation light by the distance corresponding to the thickness of the gap layer HM-C. That is, in this case, the formation of the gap layer HM-C can also suppress the peak intensity of the light spot generated at the time of reproduction through the coherent addition.

Of course, in this case, the first reflection film HM-D does not necessarily have to have wavelength selectivity.

Further, the case where the hologram recording medium has a disc shape is described above, but the hologram recording medium may have another shape such as a rectangular shape.

Further, the case where the shape of the hologram page (shape of the signal light) recorded is a circle is described above, but the shape of the signal light is not particularly limited, and the signal light may have another shape such as a square shape.

In addition, the signal light and the reference light are disposed on the inner side and the outer side, respectively, but this positional relation may be reversed.

Further, in the above example, the transmissive spatial light modulator is used as the spatial light modulator, but a reflective spatial light modulator such as a DMD (Digital Micromirror Device (registered trademark)) and a reflective liquid crystal panel may instead be used.

Further, in the above example, the spatial light modulation portion for performing both the intensity modulation and the phase modulation is constituted of the modulators that perform different modulations, but a modulator capable of performing both the intensity modulation and the phase modulation such as an FLC (Ferroelectric Liquid Crystal) modulator may be used.

Further, the structure (the slide mechanism 19 and the slide drive portion 20) for causing the hologram recording medium to slide to move is shown in FIG. 2. Alternatively, a sled mechanism and a sled drive portion for moving an optical head may instead be provided. In this case, the sled mechanism and the sled drive portion only have to be structured so that a part surrounded by a dashed line in FIG. 2 is subjected to integral sled movement as the optical head.

Further, in the above example, the present invention is applied to the recording/reproducing apparatus capable of performing both recording and reproduction, but the present invention can be desirably applied to a reproduction-only apparatus capable of performing only reproduction.

The reproduction-only apparatus can eliminate the structure in which the phase in the signal light area A2 is changed between the random-pattern/predetermined uniform phase (phase of the coherent light: “Π/2” in the embodiment) for each of recording and reproduction. That is, the phase modulator for performing variable phase modulation in response to the drive signal can be eliminated.

Further, according to the present invention, the reproduction method for the hologram recording medium is not limited to the method exemplified in the embodiment, and other methods may be used. That is, the present invention can widely be applied to a case of using a reproduction method of reading information recorded on the hologram recording medium through irradiation with the reference light and the coherent light.

It should be understood by those skilled in the art that various modifications, combinations, sub-combinations and alterations may occur depending on design requirements and other factors insofar as they are within the scope of the appended claims or the equivalents thereof.

What is claimed is:

1. A reproduction method for a hologram recording medium on which information is recorded with interference fringes of signal light and reference light, the reproduction method comprising:
generating, based on light from a first light source, the reference light and coherent light caused to have uniform amplitude and phase, and irradiating the hologram recording medium with the reference light and the coherent light, the hologram recording medium including a recording layer on which the information is recorded with the interference fringes of the signal light and the reference light, a first reflection film formed on a lower surface side of the recording layer, and a gap layer formed between the recording layer and the first reflection film; and
receiving the coherent light and a reproduction image that corresponds to recording information and is obtained as reflection light from the hologram recording medium through light irradiation in the light irradiation step, and reproducing the information based on a result of the light received.

2. The reproduction method according to claim 1,
wherein the light irradiation step includes performing irradiation with light, as the coherent light, obtained by giving a predetermined phase difference to a reference phase in the reference light.

3. The reproduction method for a hologram recording medium according to claim 2, the hologram recording medium including a substrate having a structure whose cross section has a convex-concave shape and a second reflection film formed on a convex-concave surface of the substrate on a lower surface side of the first reflection film, the first reflection film reflecting light from the first light source and causing light from a second light source to pass therethrough, the light from the second light source having a wavelength different from that of the light from the first light source,
wherein the light irradiation step includes irradiating the hologram recording medium with the light from the second light source along with the reference light and the coherent light through a common objective lens,
the reproduction method further comprising
performing, based on a result of detecting reflection light from the second light source reflected by the second reflection film, position control on the objective lens in a focus direction.

4. The reproduction method according to claim 1,
wherein the light irradiation step includes irradiating the hologram recording medium in which the gap layer has a thickness of less than 50 μm.

5. The reproduction method according to claim 4,
wherein the light irradiation step includes irradiating the hologram recording medium in which the gap layer has a thickness of 10 to 20 μm.

6. A hologram recording medium, comprising:
a recording layer on which information is recorded with interference fringes of signal light and reference light;
a first reflection film formed on a lower surface side of the recording layer; and
a gap layer formed between the recording layer and the first reflection film.

7. The hologram recording medium according to claim 6, further comprising:
a substrate having a structure whose cross section has a convex-concave shape; and
a second reflection film formed on a convex-concave surface of the substrate, the substrate and the second reflection film being disposed on a lower surface side of the first reflection film.

8. The hologram recording medium according to claim 7,
wherein the first reflection film reflects light from a first light source serving as a light source of the reference light and causes light from a second light source to pass therethrough, the light from the second light source having a wavelength different from that of the light from the first light source.

9. The hologram recording medium according to claim 6,
wherein the gap layer has a thickness of less than 50 μm.

10. The hologram recording medium according to claim 9, wherein the gap layer has a thickness of 10 to 20 μm.
